(19) United States
(12) Patent Application Publication
(10) Pub. No.: US 2008/0250498 A1
(43) Pub. Date: Oct. 9, 2008

(54) Method, Device a Program for Detecting an Unauthorised Connection to Access Points

(75) Inventors: Laurent Butti, Issy Les Moulineaux (FR); Roland Duffau, Paris (FR); Franck Veysset, Issy Les Moulineaux (FR)

Correspondence Address: MCKENNA LONG & ALDRIDGE LLP, 1900 K STREET, NW, WASHINGTON, DC, 20006, US

(73) Assignee: FRANCE TELECOM, Paris (FR)

(21) Appl. No.: 11/664,131

(22) PCT Filed: Sep. 21, 2005
(86) PCT No.: PCT/FR05/02339

§ 371 Date: Mar. 29, 2007

(30) Foreign Application Priority Data
Sep. 30, 2004 (FR) 0410352

(51) Int. Cl. H04L 9/32; G06F 12/14

(52) U.S. Cl. 726/23

(57) ABSTRACT

This method of detecting address spoofing in a wireless network, comprising the steps of obtaining frames comprising an address of a device having sent the frame and a timestamp representative of the time of sending of the frame by said device; of analyzing the timestamps included in the frames having one and the same sending device address; and of detecting a spoofing of said address according to the analysis of said timestamps.

The present invention relates to telecommunication networks wireless access technologies. It applies in particular to the IEEE 802.11 type technologies standardized by the Institute of Electrical and Electronics Engineers (IEEE). The IEEE 802.11 technologies are widely used in enterprise networks and home networks, and in hot spots. More particularly, the invention relates to wireless network piracy by access point address spoofing.

The term “frame” is used to denote a set of data forming a block transmitted in a network and containing useful data and service data, normally located in a block header field. A frame can be called a data packet, datagram, data block, or any other expression of that type.

With the success and democratization of wireless access technologies, piracy techniques have emerged.

Currently, one of the greatest risks for this type of network is attack by illegitimate access points, which consists in creating a false access point by completely spoofing the characteristics, particularly the MAC (Medium Access Control) layer address, of a legitimate access point, controlled by the wireless network administrator. The false access points that do not spoof an MAC address of a legitimate access point are relatively easy to detect by simply verifying the MAC address.

The access point is a crucial element in communication between a customer and a network. Because of this, it is a critical point, and therefore of interest to the attackers. Attacks implementing false access points have emerged in order to:
retrieve connection identifiers for users who are authenticated by means of “captive portals” by passing themselves off as a legitimate access point in order to intercept identification data such as the connection identifiers;
intercept communications by a “man in the middle” type attack, that is, by simulating the behavior of a legitimate access point with respect to the wireless user and that of a wireless user with respect to the legitimate access point in order to intercept all the communications;
open an entire enterprise network by leaving an access point directly connected to the enterprise network in open mode, that is, with no authentication or encryption of the radio channel, this access point accepting by default any connection request.

These attacks are difficult to detect when they implement an MAC address spoofing technique. It is then more difficult to distinguish two different items of equipment of the same category (access point) sending from one and the same MAC address. The advent of new, more secure standards (IEEE802.11i) will not prevent the use of illegitimate access points because the benefit for the attacker will still be present.

There is therefore a need for a method of detecting access point MAC address spoofing.

One known technique for detecting MAC address spoofing relies on the analysis of the sequence number field of the IEEE802.11 frames, or data packets (see J. Wright, “Detecting Wireless LAN MAC Address Spoofing”, http://home.jwu.edu/jwright/, Jan. 21, 2003). These sequence numbers, managed at low level in the radio card, are mandatorily incremented by one unit with each packet sent. This makes it possible to identify major variations between several successive packets sent by one and the same MAC address. By comparing these variations with predefined thresholds, it is possible to detect anomalies in the packets appearing from an MAC address, and deducing therefrom the probable spoofing of this address by an attacker. This technique entails managing thresholds that are very precise and difficult to set. It is difficult to implement on its own and to check the absence of false positives (false alarms) and false negatives (undetected attacks). The major difficulty lies in the management of the packet losses, for example in a long distance transmission. In practice, some packets are then lost, which leads to problems of false alarms, because the sequence numbers vary strongly from one packet to another. It is necessary to manage the detection thresholds very finely. This is why there is an interest in combining this type of technique with another in order to correlate the alarms and have greater confidence in a set of several techniques rather than just one.

The invention proposes a novel technique for detecting access point spoofing by the use of time indications contained in frames. Passive radio listening is used to retrieve exchanged frames. Specific frames identifying access points are stored. When two frames originating from one and the same access point are stored, time indications present in the frames are compared. If the difference between the time indications does not correspond to an expected value, then an address spoofing is detected and, where appropriate, an alarm flagging the access point address spoofing is triggered. The frames are data packets whose structure and content are defined in the communication standard used.

According to a first aspect, the invention proposes a method of detecting address spoofing in a wireless network. The method comprises the steps of obtaining frames comprising an address of a device having sent the frame and a timestamp representative of the time of sending of the frame by said device; analysis of the timestamps included in the frames having one and the same sending device address; and detection of a spoofing of said address according to the analysis of said timestamps.

According to a second aspect, the invention proposes a computer program on a data medium that can be loaded into the internal memory of a computer associated with a wireless interface, the program comprising code portions for executing the steps of the method when the program is run on said computer. The data medium can be a hardware storage medium, for example a CDROM, a magnetic diskette, a hard disk, a memory circuit, or even a transmissible medium such as an electrical, optical or radio signal.

According to another aspect, the invention proposes a device for detecting an address spoofing in a wireless network. The detection device comprises means of obtaining frames, said frames comprising an address of a device having sent the frame and a timestamp representative of the time of sending of the frame by the device; and means of analyzing the timestamps included in the frames having one and the same sending device address, said analysis means being able to detect a spoofing of said address according to the analysis of said timestamps.

According to a more general aspect, the invention proposes a monitoring system for a wireless network, comprising means for picking up a set of frames and a detection device as defined previously.

According to one particular embodiment, the frames also comprise a time interval indication, separating the sending of two successive frames by the sending device. The analysis of the timestamps of two frames corresponding to one and the same sending device address comprises the steps of computation of a difference between the timestamps of the two frames, comparison of the computed difference with the time interval, and detection of the spoofing of the address of the sender when the computed difference is not equal to a multiple of the time interval. Preferably, the multiple is less than a predefined integer.

According to another particular embodiment, the frames also comprise a destination address. The analysis of the timestamps of two frames corresponding to one and the same sending device address and having one and the same destination address comprises the steps of computation of a difference between the timestamps of the two frames, comparison of the computed difference with a threshold, and detection of the spoofing of the address of the sender when the computed difference is greater than or equal to said threshold.

According to a preferred embodiment, an address spoofing is detected if the difference between the timestamps of the two frames is zero.

The invention will be better understood, and other features and advantages will become apparent from reading the description that follows, the description referring to the appended drawings in which:

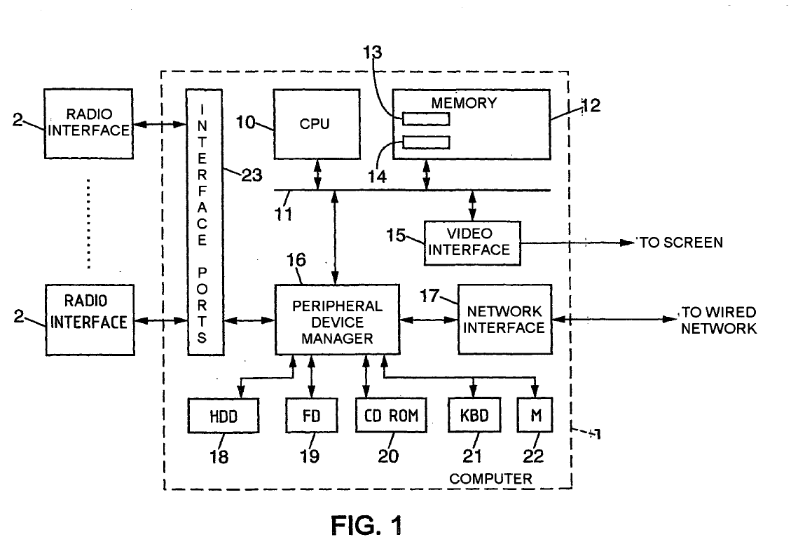

FIG. 1 represents an access point spoofing detection device according to the invention,

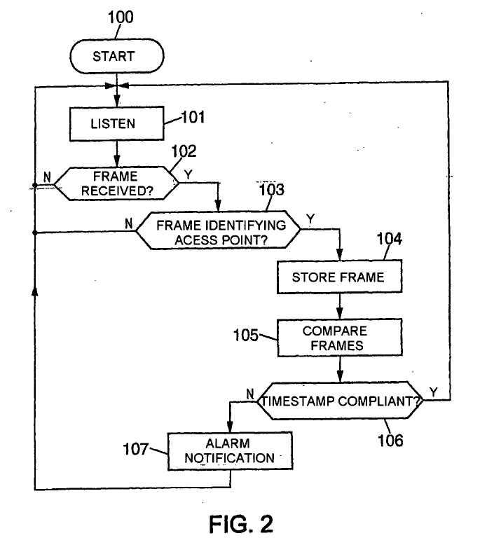

FIG. 2 represents an exemplary operating flow diagram of the device of FIG. 1,

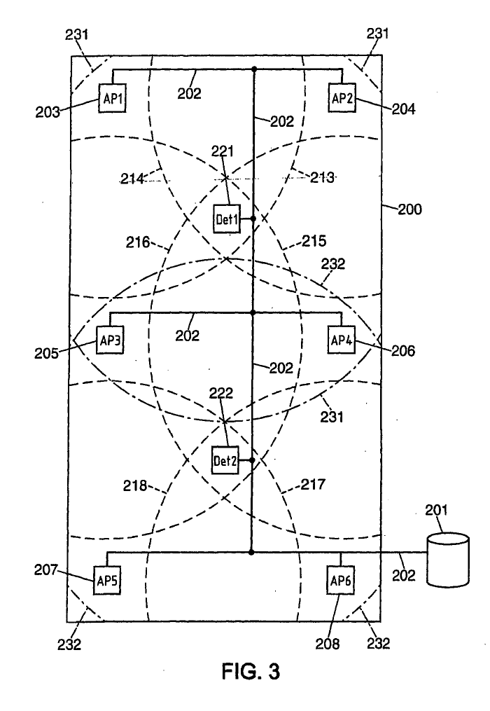

FIG. 3 represents an exemplary implementation of a detection device in a wireless network.

Initially, in order to understand the invention, it is appropriate to detail the method of associating a customer with an access point according to the IEEE 802.11 standard, the association corresponding to the connection of a customer to the network by radio link. The association takes place in two phases:
firstly, a customer device must identify at least one access point;
an access point being suitable for the customer device, if several access points are available, the customer chooses the one that seems to be the best suited according to various criteria of choice, the customer asks to be authenticated with the access point;
if the authentication is successful, then the customer asks to be associated with the access point.

An attack by access point spoofing takes place from the access point identification phase, before the authentication request. This identification phase can be carried out according to two techniques.

A first technique is implemented passively by the customer device. The customer device listens to one or more radio channels, successively or simultaneously, to look for frames having specific frames, called BEACON frames in the IEEE802.11 standard. The BEACON frames are sent regularly by an access point and contain a variety of information including: a network identifier (SSID), the MAC address of the access point, and communication parameters that can be used by the access point. Based on this information, the customer has information with which to begin a communication with the access point and, where appropriate, to choose the most appropriate access point for communicating if several access points are detected.

A second technique is implemented actively by the customer device; this is in particular the case when the access points operate in “hidden” mode. The customer sends an access point search frame, called PROBE REQUEST frame in the IEEE802.11 standard. The PROBE REQUEST frames contain, among other things, the network identifier (SSID) sought and the MAC address of the customer device. An access point corresponding to the called network which receives a PROBE REQUEST frame responds by sending a PROBE RESPONSE frame which comprises information including: a network identifier (SSID), the MAC address of the access point, the MAC address of the customer device, and communication parameters that can be used by the access point.

When using an illegitimate access point on the radio channel, the attacker normally uses a complete access point spoofing technique: same network name (SSID), same MAC address. However, it does not normally use the same radio channel for radio interference reasons.

To detect an attack, the invention is based on a parameter included in the BEACON frames and the PROBE RESPONSE frames, namely a timestamp. This is mandatory for these two types of frames, it is encoded on 64 bits and is expressed in microseconds, which means that 2⁶⁴ microseconds can be represented (approximately 585 000 years). The timestamp of a frame comprises a time indication relating to the sending of this frame, here comprising the value of a clock of the access point having sent the frame at the time of sending of that frame. The clock is normally set to zero when the access point is started up. The timestamp is generated by the program driving the 802.11 radio card at the time of sending of the frame. It is therefore possible, using this stamp, to know how long ago the access point was started up.

The invention therefore relies on the detection of a difference between the timestamps generated by two access points: one legitimate and the other illegitimate. In practice, if two access points communicate two different timestamps at the same time although they have the same MAC address, it is then possible to distinguish them, and therefore confirm that an attacker is in the process of spoofing the MAC address of a legitimate access point. This is valid for the BEACON frames and the PROBE RESPONSE frames.

In a preferred embodiment, both types of attacks are detected simultaneously. However, it is possible to process the detection of these two types of attacks separately.

To detect attacks using BEACON frames, it should be noted that the BEACON frames are regularly sent by an access point. Each BEACON frame has a timestamp which is incremented by the time between the sending of two frames. Now, the time between two BEACON frames corresponds to a fixed time interval which is indicated by an interval indication (called BEACON INTERVAL in the IEEE802.11 standard) which is included in the frame. Thus, when two BEACON frames are received, it is important to check that the timestamp is indeed incremented by a time corresponding to the BEACON interval. Moreover, it is possible for certain frames to be lost for various reasons. To avoid false alarms due to a loss of frames, it is possible to simply check that the time difference between two frames is equal to a non-zero multiple of the BEACON interval. If two frames are received with the same timestamp, in other words if the time difference between the two frames is zero, it is obvious that the frame has been sent twice, by a legitimate access point and by an illegitimate access point.

One way of identifying this type of attack is as follows:

a) Listen to the radio channel passively. This listening can be done on all the channels of the frequency band used according to the IEEE802.11 standard, or on one channel at a time, performing channel hops at regular intervals. In the case of channel hops, it is obvious that many frames will be lost but, since the BEACON frames are sent repetitively, obviously it will be possible to receive two frames in the case of an attack and the timestamps can be compared to check their conformity.
b) Store the frames corresponding to received BEACON frames in a table in a memory for a given time. There is no need to store the frames indefinitely because several frames originating from a legitimate access point add the same information. And if an access point stops sending frames for a certain time, it is because it is no longer operating. It is best to use a rolling study time window which is big enough to allow all the channels to be scanned if listening to one channel at a time, and big enough to overcome any frame losses because of the transmission quality but short enough not to have to use memory space unnecessarily. As an example, a maximum given time of ten seconds may be appropriate.
c) On receiving a BEACON frame, and after having stored the frame in the table, look in the table for a previous BEACON frame having the same access point MAC address, that is, the same sending address.
d) When a BEACON frame sent by the same access point has been found, compare the timestamp of the frame that has just been received with the timestamp of the previous frame, and compute the difference between the two timestamps:
If the value of the difference between the timestamps is not a multiple of the BEACON interval, then the current and previous frames have been sent by two different items of equipment: illegitimate access point detected. Or, if the value of the difference between the timestamps is equal to zero, then the same frame has been sent twice, which is a sign of an active attack from an illegitimate access point which has synchronized its timestamp with that of the legitimate access point, but the false access point is still detected. It is then advisable to generate an alarm and delete the two frames concerned from the table to reset the detection function.
If, however, the value returned is equal to a non-zero multiple of the BEACON interval, then the frame is indeed valid and sent by an item of equipment whose MAC address has not been spoofed. The previous frame can be deleted from the table and only the latest frame received kept.
   e) Recommence at step a).

The method described above can be improved by considering an additional detection threshold. As seen previously, an illegitimate access point can be synchronized with the legitimate access point. The detection is then based on the repetition of a timestamp. However, it is possible for an illegitimate access point to anticipate this detection by supplying a timestamp that uses a timestamp very far removed from the timestamp of the legitimate access point while retaining a stamp difference that is a multiple of the BEACON interval. To this end, a comparison with a maximum difference threshold is added, the threshold being equal to the rolling study time window. The threshold is added simply by assuming that the multiple of the BEACON interval must be less than a predefined integer corresponding to the rolling study time window divided by the BEACON interval. In this case, it is advisable to retain all the stored frames that have been received during a period of time corresponding to the rolling study time window.

To detect attacks using PROBE RESPONSE frames, it should be noted that these messages are one-off messages sent in response to a PROBE REQUEST frame sent by a customer device. This mechanism is implemented when the access points operate in “hidden” mode. Normally, a PROBE REQUEST frame has a corresponding single PROBE RESPONSE frame. However, it is possible for the PROBE RESPONSE frame not to be correctly received by the customer device and for the latter to repeat its request and for the same access point to send a few PROBE RESPONSE frames to one and the same customer device. There are not very many of these messages, and they are relatively close together in time because they correspond to repetitions of PROBE REQUEST frames that are, for example, sent every 100 ms by the customer device in the absence of a response.

In order to cover the case where several PROBE RESPONSE frames are sent, it is best to compare the timestamps of two PROBE RESPONSE frames. There are two possibilities in the event of an attack. In a first case, the timestamp of the PROBE RESPONSE frame from the illegitimate access point corresponds to the period of time since its initialization. The probability that this timestamp is close to that of the legitimate access point is relatively low, so it can be considered that if two timestamps are too far apart in time, for example by a period of time greater than a few seconds, they cannot be from the same access point. In a second case, so as to circumvent the timestamp, the illegitimate access point could use the same timestamp as a PROBE RESPONSE frame. In this second case, the detection of two PROBE RESPONSE frames having the same timestamp means that the two frames do not originate from the same access point.

It would be possible to consider a third case where the illegitimate access point is synchronized with the legitimate access point in order to supply consistent time messages. However, if the time needed to synchronize the illegitimate access point with the legitimate access point is considered, it is improbable for such a synchronization to be able to be done successfully because there are few messages sent over a fairly short period of time.

One way of identifying this type of attack is as follows:

a) Listen to the radio channel passively. This listening is done preferably on all the channels of the frequency band used according to the IEEE802.11 standard in order to avoid any loss of frames.
b) Store the frames corresponding to PROBE RESPONSE frames in a table in a memory for a given period of time. There is no need to store the frames indefinitely because these frames are inherently one-off. It is best to use a rolling study time window that is big enough to be sure that no PROBE RESPONSE frame can be taken into account after a first frame, but short enough not to have to unnecessarily use memory space. As an example, a maximum given period of time of 10 seconds may be appropriate.
c) On receiving a PROBE RESPONSE frame, and after having stored its frame in the table, look in the table for a frame corresponding to a previous PROBE RESPONSE frame having the same access point MAC address, that is, the same sending address, and the same user device MAC address, that is, the same destination address.
d) When a PROBE RESPONSE frame sent by the same access point and addressed to the same user device has been found, compare the timestamp of the frame that has just been received with the timestamp of the previous frame, and compute the difference between the two timestamps:
If the value of the difference as an absolute value between the timestamps is greater than a threshold of a few seconds, then the current and previous frames have been sent by two different items of equipment: illegitimate access point detected. Or, if the value of the difference between the timestamps is equal to zero, then the same frame has been sent twice, which is the sign of an active attack from an illegitimate access point. It is then advisable to generate an alarm and delete the two frames concerned from the table to reset the detection function.
If, however, the difference value is less than the threshold and non-zero, then the frame is indeed valid and sent by an item of equipment whose MAC address has not been spoofed. The previous frame can be deleted from the table and only the latest frame received kept.
   e) Recommence at step a).

The illegitimate access point detection function can be implemented by a computer provided with a radio interface compliant with one of the physical layers of the IEEE802.11 standard using a radio link. Physical radio layers are in particular defined by the IEEE802.11a and IEEE802.11b standards, or even the IEEE802.11g standard. FIG. 1 describes a detection device comprising a computer 1 linked to a plurality of radio interfaces 2.

The computer 1 is, for example, a standard computer which comprises a central processing unit 10 linked to a central bus 11. A memory 12 which can comprise several memory circuits is linked to the bus 11 to cooperate with the central processing unit 10, the memory 12 serving both as data memory and program memory. Areas 13 and 14 are provided for storing BEACON frames and PROBE RESPONSE frames. A video interface 15 is linked to the bus 11 in order to be able to display messages for an operator. In our example, the screen is not shown because it is not necessary. However, according to one embodiment variant, it is possible to use the screen to display alarms to an operator when an illegitimate access point is detected.

A peripheral device management circuit 16 is linked to the bus 11 to provide the link with various peripheral devices according to a known technique. Of the peripheral devices that could be linked to the peripheral device management circuit, only the main ones are shown: a network interface 17 which enables communication with a wired network (not shown), a hard disk 18 acting as main read-only memory for programs and data, a diskette drive 19, a CDROM drive 20, a keyboard 21, a mouse 22 and a standard interface port 23. The diskette drive 19, the CDROM drive 20, the keyboard 21 and the mouse 22 are removable, they can be removed after installing access point spoofing detection software on the hard disk 18. The hard disk 18 can be replaced by another, equivalent type of read-only memory, such as a Flash memory for example. The standard interface port 23 is a port compatible with a standard for communications between the computer and external interfaces. In our example, the interface port 23 is, for example, a PCMCIA standard port or a USB standard port.

In the preferred example, at least one radio interface 2 is connected to the interface port 23, but according to different variants, it is possible to use several radio interfaces 2. Conventionally, the radio interfaces compatible with the IEEE802.11 standard have radio means that allow only a small number of radio channels to be listened to simultaneously.

If there is a desire to listen to all the communication band, it is best to have enough interfaces to listen to all the channels of the band. When setting up a radio access point spoofing detection program, the interface or interfaces are configured to listen to all the radio traffic on each channel listened to.

If a reduced listening is sufficient, for example if only attacks based on BEACON frames are to be detected, a single interface will be sufficient. When setting up a detection program, this interface will be configured to listen to all the messages exchanged over a channel, and the program will regularly change channels to listen sequentially to all the channels.

FIG. 2 illustrates an operating flow diagram of a program implementing the detection of access point spoofing. In this preferred example, both types of frames are detected with global listening over all the radio communication band.

The program begins with a step 100, during which the radio interfaces 2 are configured to listen globally to receive and decode all the frames conveyed by radio over the channels being listened to. During this step 100, the radio interfaces are positioned on channels in order to cover all the channels that can be used by a wireless network in a given space. The detection device is then in a listening step 101.

The listening step 101 is a waiting step for all the radio interfaces 2. If a radio interface receives no frame, the latter keeps listening. If a radio interface 2 receives a frame, then it decodes it and transmits the frame to the central processing unit 10. The test 102 illustrates this change of state for a radio interface 2. It should be noted that several interfaces can receive frames at the same time and frames can be delayed in the processing at the interface manager level which serves as a buffer between the radio interfaces 2 and the central processing unit 10. This type of wait depends on the operating system of the computer and will not be described.

On receiving a frame, the central processing unit identifies, during a test 103, if it is a BEACON frame or a PROBE REQUEST frame. If it is not a BEACON or PROBE REQUEST frame, then the operation is stopped there and the device returns to the listening step 101. If it is a BEACON or PROBE REQUEST frame, the frame is then stored in the memory 12 during a storage step 104.

During the storage step 104, the BEACON frames are stored in a first table corresponding to the memory area 13, and the PROBE REQUEST frames are stored in a second table corresponding to the memory area 14. During this storage step, the tables are purged in order to delete the stored frames that are too old in order to avoid an unnecessary storage of data. The frames considered too old are those that have been stored for a time period longer than the study time window. Then, a comparison step 105 is performed.

The comparison step 105 consists in comparing the last frame stored with all the frames present in the table in which it has been stored. Thus, for the BEACON frames, a search is conducted in the table for all the previous BEACON frames having the same sending MAC address, then, for the identified frames, the conformity of the timestamps is checked, as indicated previously. For the PROBE RESPONSE frames, a search is conducted in the table for all the frames corresponding to previous PROBE RESPONSE frames having the same sending MAC address and the same destination MAC address, and, for the identified frames, the conformity of the timestamps is checked as indicated previously. At the end of the comparison, the test 106 is performed.

The test 106 closes the processing performed on the frame, if the timestamp complies with the timestamp of each frame having been the subject of the comparison, then the central processing unit returns to the listening step 101. If the difference does not comply with an expected difference as defined previously, then an alarm step 107 is performed.

The alarm step 107 consists in reporting an alarm indicating that an access point is in the process of being attacked by address spoofing. The alarm is preferably reported by sending an electronic message, via the network interface 17, to a network server which monitors the radio access points. If the detection device is linked to a monitoring screen, it is also possible to display the alarm on the monitoring screen. Then, as indicated previously, the stored frames that are the subject of the alarm are deleted from the table in which they were stored and the program returns to the listening step 101.

FIG. 3 represents a wireless network in a large room 200. A server 201 supervises a wired network 202. Access points 203 to 208 are linked to the wired network 202 and serve as gateways between the wireless network and the wired network. The access points 203 to 208 are positioned in the room 200 at different locations in order to obtain a good radio coverage.

An access point operating, for example, in the frequency range located at 5 GHz can cover several hundreds of m². Moreover, the signals at 5 GHz largely do not pass through obstacles such as partitions and the coverage of an access point can be reduced to a few tens of m². To cover an airport transfer lounge or a floor of offices, several access points are necessary.

In the example of FIG. 3, the transmission conditions are assumed to be ideal to represent respectively the coverage areas 213 to 218 of the access points 203 to 208.

In order to check that no attack by access point address spoofing is taking place, it is advisable to position detection devices 221 and 222. Each detection device 221 or 222 corresponds, for example, to the device represented in FIG. 1 and implements a program corresponding to the flow diagram of FIG. 2.

The detection devices 221 and 222 are linked to the network 202 and each has a radio coverage 231 and 232 represented by broken lines. Normally, the detection devices are also positioned to ensure a radio coverage over the entire room 200. However, it is possible for areas of the room 200 not to be physically accessible to a device seeking access to the network and therefore it is not necessary to cover them. Similarly, an area that would not be covered by at least one of the access points cannot be monitored because the intruder will necessarily be in an area covered by an access point to receive frames from the legitimate access point.

The placement of the detection devices is subject to the same radio coverage constraints as the access points. However, the access points also need to be able to ensure a certain data rate which can impose numerous cross checks on their coverages. The devices are not subject to this problem of minimum rate to be provided so there can be fewer of them than the access points. The detection devices having common coverage areas also provide two alarms instead of one if an intruder is located in a common area, which makes the detection more reliable.

1. A method of detecting address spoofing in a wireless network, comprising the following steps:
obtaining frames comprising an address of a device having sent the frame and a timestamp representative of the time of sending of the frame by said device;
analyzing the timestamps included in the frames having one and the same sending device address; and
detecting a spoofing of said address according to the analysis of said timestamps.

2. The method as claimed in claim 1, wherein the frames also comprise a time interval indication, separating the sending of two successive frames by the sending device, and wherein analyzing the timestamps of two frames corresponding to one and the same sending device address comprises the following steps:
computing a difference between the timestamps of the two frames,
comparing the computed difference with the time interval,
detecting the spoofing of the address of the sender when the computed difference is not equal to a multiple of the time interval.

3. The method as claimed in claim 2, wherein the multiple is less than a predefined integer.

4. The method as claimed in claim 1, wherein the wireless network is of IEEE 802.11 type and wherein the frames are BEACON frames.

5. The method as claimed in claim 1, wherein the frames also comprise a destination address, and wherein analyzing the timestamps of two frames corresponding to one and the same sending device address and having one and the same destination address comprises the following steps:
computing a difference between the timestamps of the two frames,
comparing the computed difference with a threshold,
detecting the spoofing of the address of the sender when the computed difference is greater than or equal to said threshold.

6. The method as claimed in claim 2, wherein an address spoofing is detected if the difference between the timestamps of the two frames is zero.

7. The method as claimed in claim 5, wherein the wireless network is of IEEE 802.11 type and wherein the frames are PROBE RESPONSE frames.

8. A computer program on a data medium that can be loaded into the internal memory of a computer associated with a wireless interface, the program comprising code portions for executing the steps of the method as claimed in any one of the preceding claims when the program is run on said computer.

9. A device for detecting an address spoofing in a wireless network, comprising:
means of obtaining frames, said frames comprising an address of a device having sent the frame and a timestamp representative of the time of sending of the frame by the device; and
means of analyzing the timestamps included in the frames having one and the same sending device address, said analysis means being able to detect a spoofing of said address according to the analysis of said timestamps.

10. The device as claimed in claim 9, wherein the frames also comprise a time interval indication separating the sending of two successive frames by the sending device, and wherein the analysis means comprise:
computation means for computing a difference between the timestamps of two frames having one and the same sending device address,
comparison means for comparing the computed difference with the time interval,
detection means for detecting the spoofing of the address of the sender when the computed difference is not equal to a multiple of the time interval.

11. The device as claimed in claim 9, wherein the frames also comprise a destination address, and wherein the analysis means comprise:
computation means for computing a difference between the timestamps of two frames having one and the same sending device address and one and the same destination address,
comparison means for comparing the computed difference with a threshold,
detection means for detecting the spoofing of the address of the sender when the computed difference is greater than or equal to said threshold.

12. A monitoring system for a wireless network, comprising means for picking up a set of frames and a device as claimed in any one of claims 9 to 11.
